(19) United States
(12) Patent Application Publication
(10) Pub. No.: US 2015/0212604 A1
(43) Pub. Date: Jul. 30, 2015

(54) TOUCH PEN HAVING SIGNAL CABLE

(71) Applicant: Da-Chung Wu, Taipei City (TW)

(72) Inventor: Da-Chung Wu, Taipei City (TW)

(21) Appl. No.: 14/168,454

(22) Filed: Jan. 30, 2014

(51) Int. Cl. G06F 3/0354; G06F 3/039

(52) U.S. Cl. CPC G06F 3/03545; G06F 3/039

(57) ABSTRACT

A touch pen includes a touch head, a pen body and a signal cable. The pen body includes a first end and a second end. The first end is connected to the touch head. The signal cable has two ends, on which a first signal connector head and a second signal connector head are respectively disposed. The signal cable is combined with the pen body. The user only needs to carry the touch pen of the invention to perform the screen touch operation or perform the signal/electric power connection. The touch pen, which being placed into the knapsack, cannot twine around other articles to enhance the carrying convenience. This also overcomes the conventional problem of the need of carrying the corresponding components to perform the operations.

### BACKGROUND OF THE INVENTION

(1) Field of the Invention

The invention relates to a touch pen, and more particularly to a touch pen having a signal cable for a connection of electronic device signals or electric power.

(2) Description of the Prior Art

The progressing technology makes many electronic devices have powerful functions day after day. More particularly, after the electronic device is equipped with a touch screen, a lot of convenience in inputting texts is brought to users. In the past, when texts are inputted on a mobile phone, the user needs to repeatedly press the limited numeric keys and then select the text. So, a lot of time has to be spent to complete a sentence. Thus, most of the conventional mobile phones are simply used in talking or short message sending.

After the touch screen becomes popular, the use habit of the mobile phone is significantly changed, and the touch screen is also applied to a computer. Because the keyboard can be omitted, the screen of the mobile phone is correspondingly enlarged. By displaying virtual keys on the screen, the user can directly press the virtual keys. Alternatively, using the handwritten recognition function can directly recognize the text written on the screen by the user. No matter which method is applied, the powerful function attracts more and more users. However, many users would encounter the following two problems in use.

The first problem relates to the width of the finger. Although the screen size is enlarged, the finger of a certain user is thicker than the displayed virtual key. Thus, the inadvertent touch or multiple touches on the virtual keys frequently occur in the touch process. After considering the use habit of the ordinary users, a touch pen is developed with the model of a pen that is frequently used, so that the user can precisely click or write a text on the touch screen to enhance the input convenience. However, most devices are not formed with pen slots for accommodating the touch pens, and the user needs to carry the touch pen additionally.

The second problem relates to the signal connection. Due to the powerful function of the electronic device, the electronic device can be connected to other devices through a signal transmission cable to perform the data or electric power transmission. However, the signal transmission cable is a component independent from the device, and the user may also carry the cable in another knapsack.

According to the above-mentioned contents, it is obtained that the user needs to carry the two articles at any time in order to take the touch pen for operation or to take the signal transmission cable for connection transmission. However, the inconvenience is brought to the user. More particularly, the signal transmission cable tends to twine around other articles.

### SUMMARY OF THE INVENTION

In view of the above-mentioned problems, the invention provides a touch pen having a signal cable. The user only needs to carry the touch pen of the invention to perform the touch operation on the screen, or to perform the signal/electric power connection. In addition, the touch pen cannot twine around other articles in the knapsack, thereby enhancing the carry convenience.

The touch pen of the invention includes a touch head, a pen body and a signal cable. The pen body includes a first end and a second end. The first end is connected to the touch head. The signal cable has two ends on which a first signal connector head and a second signal connector head are respectively disposed, wherein the signal cable is combined with the pen body.

Accordingly, the invention combines the touch pen with the signal cable to overcome the prior art problem that the operation cannot be completed until the corresponding components are carried. In addition, the signal cable is combined with and disposed in the pen body in this invention, and thus cannot twine around other articles.

Also, the first signal connector head and the second signal connector head are disposed on the first end and the second end of the pen body, respectively, to facilitate the assembling processes.

In addition, the pen body is formed with a strip-like slot, the strip-like slot has one end connected to the first end or the second end, and the strip-like slot has a width slightly smaller than or equal to a diameter of the signal cable. Thus, the first signal connector head or the second signal connector head can be turned arbitrarily after being rotated out of the pen body to facilitate the inserted connection of the signal connector head in conjunction with various positions. In addition, after being used, the signal cable can be placed into the slot and thus accommodated within the pen body.

Also, the pen body may be made of a resilience material or a flexible material, so that the orientation of the first signal connector head or the second signal connector head on two ends can be changed in conjunction with the conditions of various connection portions.

Moreover, the pen body further includes a first section and a second section, and a rotatable mechanism is disposed between and connected to the first section and the second section, so that the included angle between the first section and the second section can be changed.

Also, the touch head may further include a connector head accommodating chamber, and the first signal connector head is disposed in the connector head accommodating chamber when the touch head is connected to the first end. Thus, the effect of protecting the connector head and the dustproof effect can be obtained.

Preferably, the second end is further covered with a cover body for protecting the second signal connector head to achieve the effect of preventing the dust from entering the second signal connector head.

The pen body further has a clip for clipping onto the clothes, pocket, knapsack, or the like so that the touch pen can be conveniently carried by the user.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a pictorial view showing an embodiment of the invention.

FIG. 2 is an exploded view showing components of the embodiment of the invention.

FIG. 3 is another exploded view showing components of the embodiment of the invention at another viewing angle.

FIG. 4 is a schematically cross-sectional view showing the embodiment of the invention.

FIG. 5 is another schematically cross-sectional view showing the embodiment of the invention.

FIG. 6 is a schematic illustration showing an application of the embodiment of the invention.

FIG. 7 is a pictorial view showing another embodiment of the invention.

FIG. 8 is a pictorial view showing still another embodiment of the invention.

FIG. 9 is a schematically cross-sectional view showing the embodiment of FIG. 8.

FIG. 10 is a schematic illustration showing an application of the embodiment of FIG. 8.

### DETAILED DESCRIPTION OF THE PREFERRED EMBODIMENTS

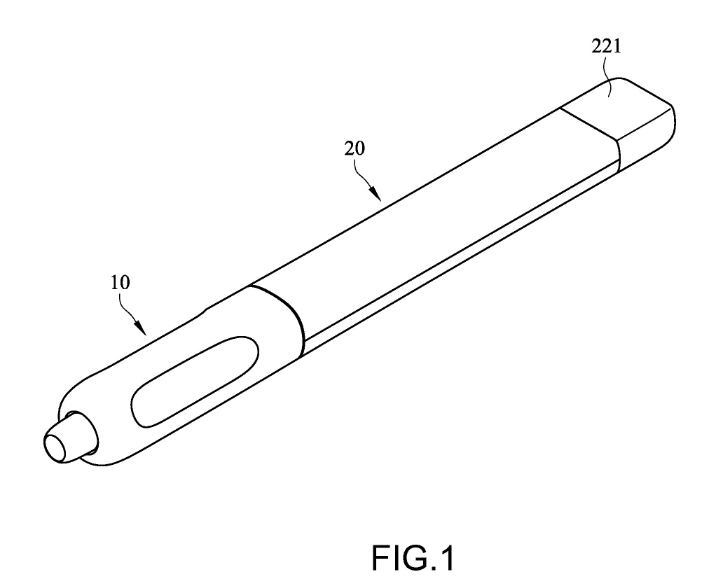

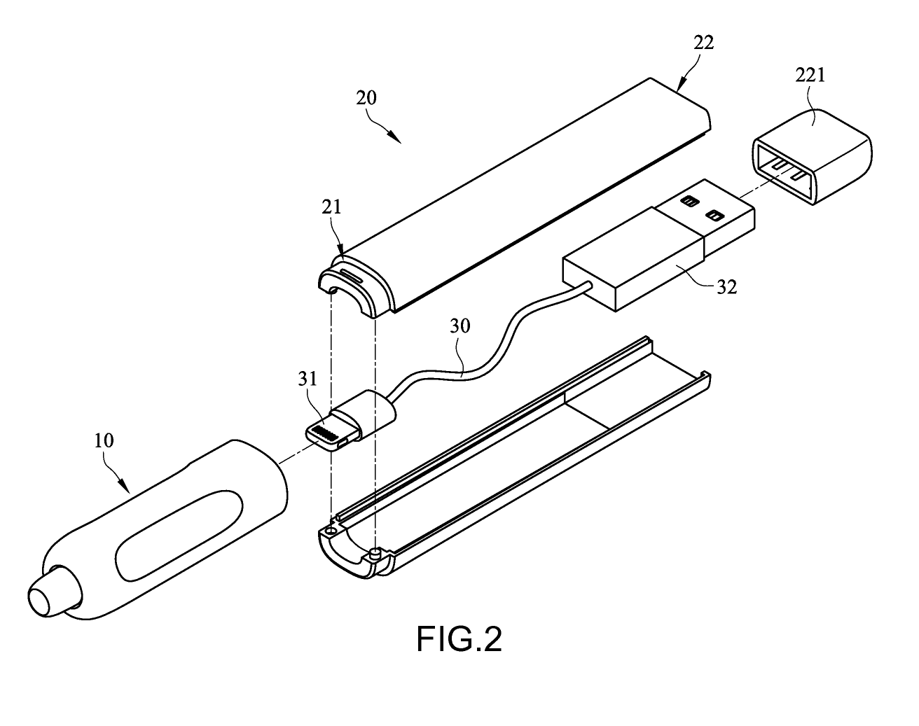

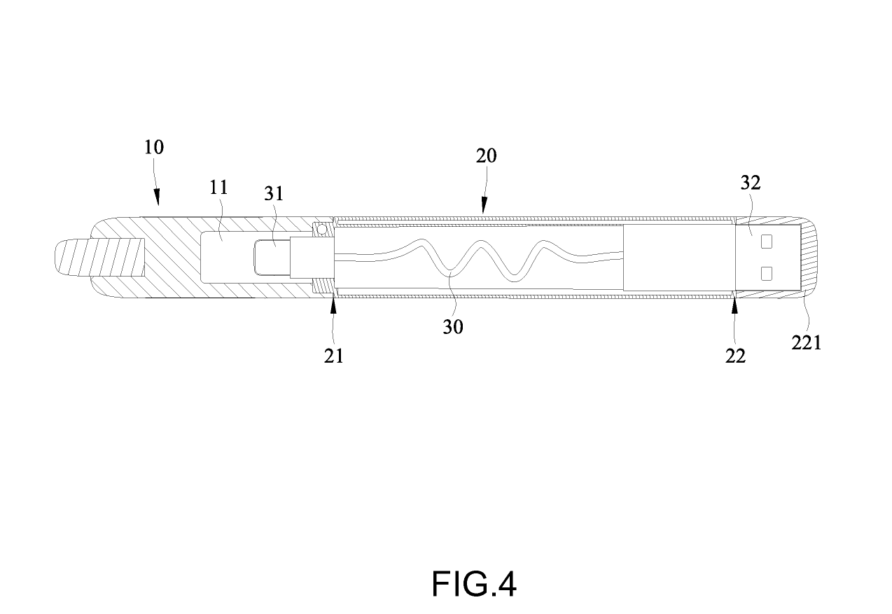

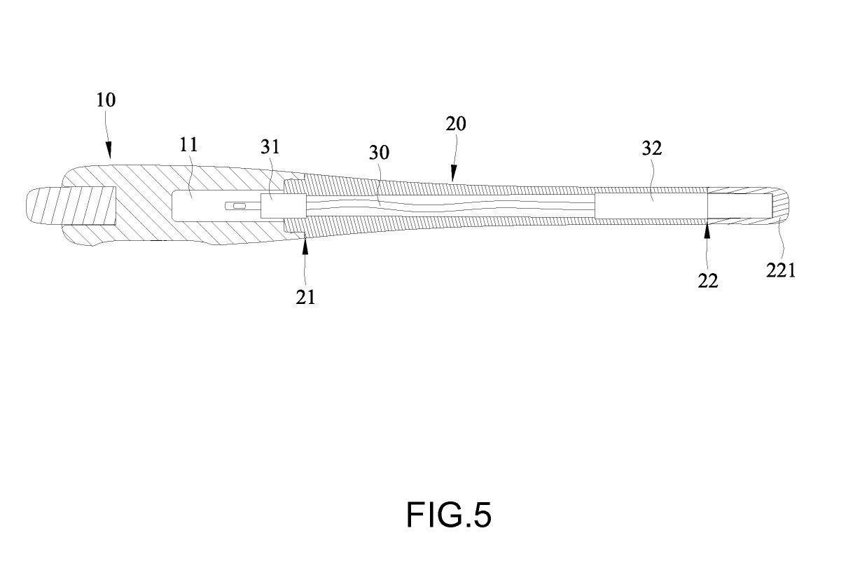

Referring to FIGS. 1 to 5, the touch pen of this embodiment includes a touch head 10, a pen body 20 and a signal cable 30.

The touch head 10 is used to operate a touch screen and may be modified in correspondence with different types of touch screens, such as capacitive, resistive or voltage-type touch screens. Also, if the touch head 10 is applied to the capacitive screen, the touch head 10 and the pen body 20 may be made of an electroconductive material or include the electroconductive material.

The pen body 20 includes a first end 21 and a second end 22, wherein the first end 21 is connected to the touch head 10. The signal cable 30 has two ends, on which a first signal connector head 31 and a second signal connector head 32 are respectively disposed. In addition, the signal cable 30 is combined with the pen body 20, and the first signal connector head 31 and the second signal connector head 32 are disposed on the first end 21 and the second end 22 of the pen body, respectively.

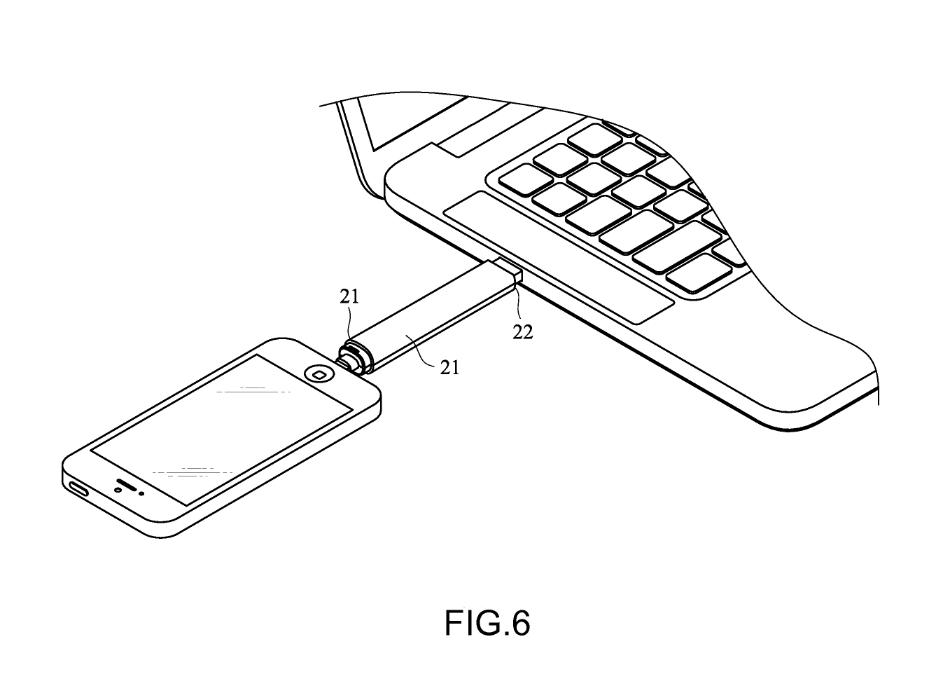

So, as shown in FIG. 1, the user can hold the touch head 10 to operate the touch screen in an ordinary condition. When the signal or electric power connection is needed, the touch head 10 is removed so that the first signal connector head 31 is exposed to the first end 21 of the pen body 20, and the first signal connector head 31 and the second signal connector head 32 may be inserted into the sockets of the corresponding devices, respectively, to perform the signal or electric power transmission, as shown in FIG. 6.

This embodiment has the advantage that the touch pen can be easily carried. The signal cable 30 is combined with the pen body 20, so the problem of twining around other articles cannot occur. The user only needs to carry one article to perform the charging, data transmission and touch screen operation.

Furthermore, the pen body 20 may be made of a resilience material or a flexible material so that it can be bent in conjunction with the relative position between the two devices, and the first signal connector head 31 and the second signal connector head 32 may be inserted into the corresponding sockets.

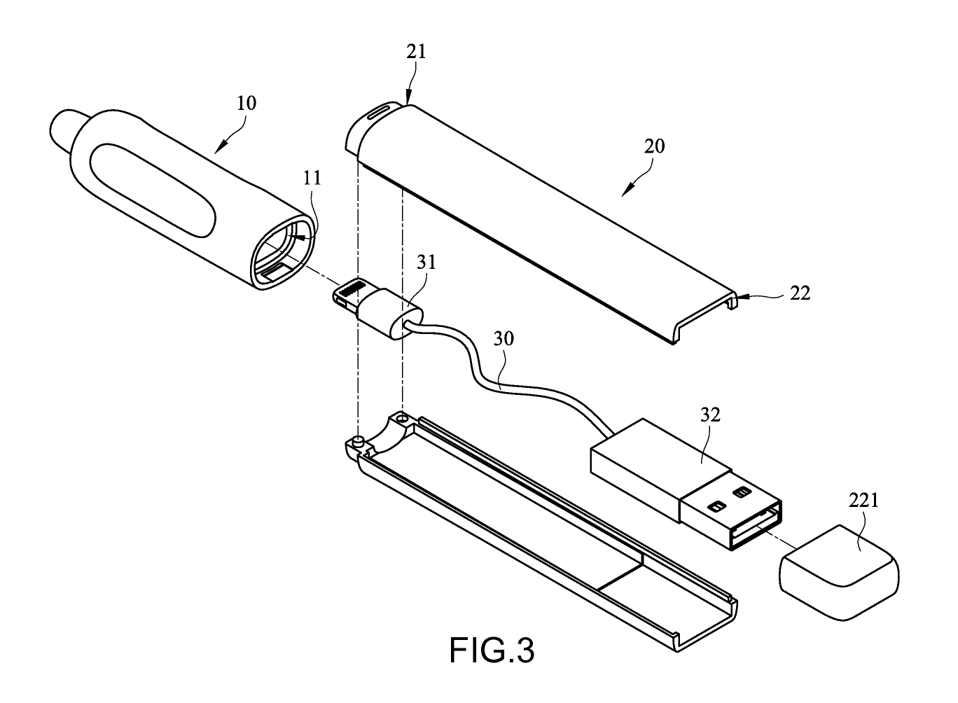

Also, as shown in FIGS. 3 to 5, the touch head 10 further includes a connector head accommodating chamber 11. When the touch head 10 is connected to the first end 21, the first signal connector head 31 is disposed in the connector head accommodating chamber 11. The use of this connector head accommodating chamber 11 can protect the first signal connector head 31, and decrease the dust accumulation. In addition, the touch head 10 may be connected to the first end 21 via several connection structures, such as engaging structures, rotatable locking structures or fitting structures. Since these connection structures pertain to the conventional structures, detailed descriptions thereof will be omitted.

Referring to FIG. 3, the second end 22 also includes a cover body 221 for covering the second signal connector head 32 to achieve the protection and dustproof effects. The cover body 221 may be engaged or fit with the second signal connector head 32, or directly engaged with, rotatably locking with or fit with the second end 22 using the conventional structures, which will not be described in detail.

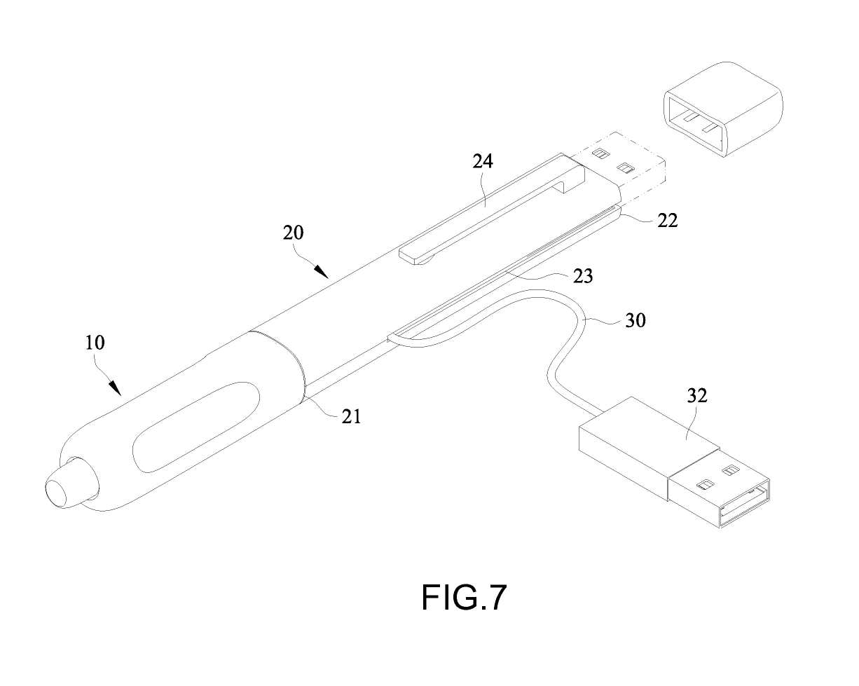

As shown in FIG. 7, the pen body 20 is formed with a strip-like slot 23. The strip-like slot 23 has one end connected to the second end 22 (may also be connected to the first end 21), and has the width slightly smaller than or equal to the diameter of the signal cable 30. So, the second signal connector head 32 may be pulled out (the outward extending length is reserved), so that the second signal connector head 32 is not restricted by the second end 22. Then, the signal cable 30 is pulled out along the strip-like slot 23 to achieve the object of changing the included angle between the first signal connector head 31 and the second signal connector head 32. After being used, the signal cable 30 can be plugged into the pen body 20 through the strip-like slot 23 to facilitate the storage and enhance the convenience in use.

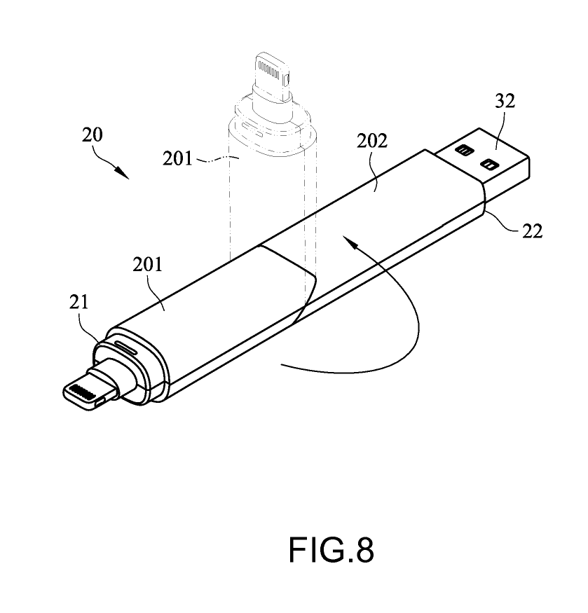

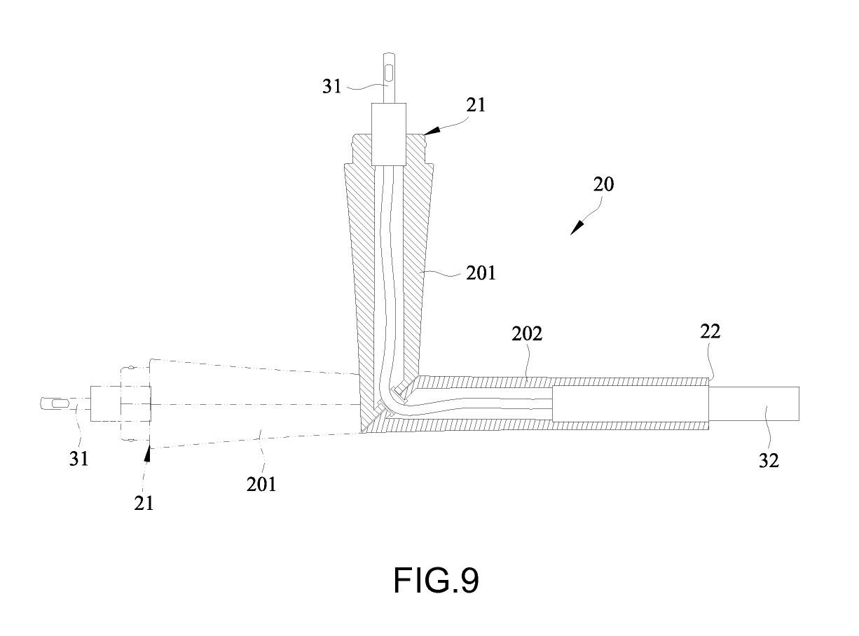

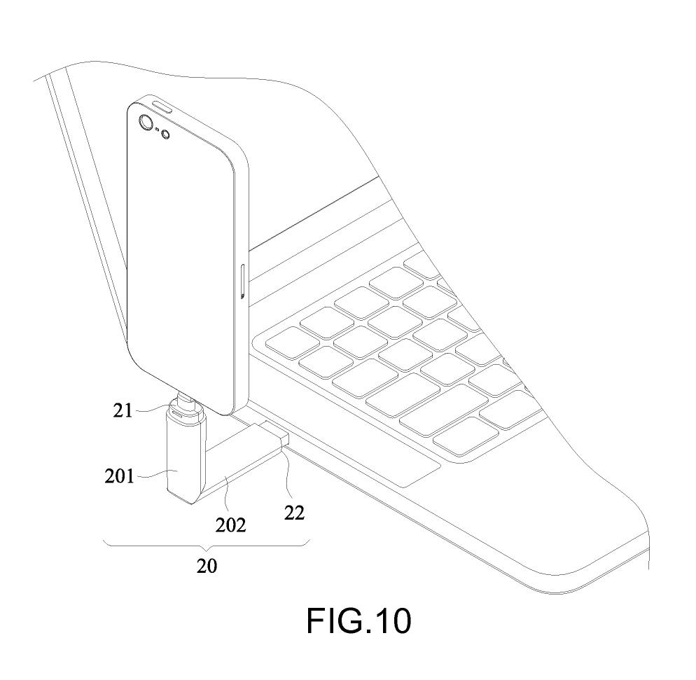

Referring to the embodiment of FIGS. 8 to 10, the pen body 20 further has the structure changes so that the pen body 20 may be turned. As shown in these drawings, the pen body 20 includes a first section 201 and a second section 202. The first section 201 has one end connected to the first end 21. The second section 202 has one end connected to the second end 22. In addition, a rotatable mechanism (not shown) is disposed between and connected to the first section 201 and the second section 202. Thus, the first section 201 and the second section 202, which are originally arranged on a straight line, may enter the state with the included angle therebetween after rotation, so that the included angle between the first signal connector head 31 and the second signal connector head 32 can be changed, and the touch pen can be used, as shown in FIG. 10.

There are many types of rotatable mechanisms. For example, as shown in the drawings, the contact surfaces between the first section 201 and the second section 202 are inclined surfaces, and rotatable connecting devices are disposed on the two inclined surfaces to achieve the object of rotating and changing the angle. The rotatable mechanism shown in the drawings is only one of the prior arts and will be easily understood by those skilled in the art. So, the detailed structure of the rotatable mechanism will not be described. Also, there are many equivalent structures that may be derived from the rotatable mechanism, and any mechanism that allows the first section 201 to rotate relatively to the second section 202 is regarded as the equivalent mechanism of the rotatable mechanism.

In addition, as shown in FIG. 7, the pen body 20 may further have a clip 24 to clip the clothing, knapsack or the like.

In summary, the disclosed embodiments of the invention have the wide application range, have the increased production efficiency, have the reduced manufacturing costs, and thus have the industrial utility. New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A touch pen, comprising:
a touch head;
a pen body comprising a first end and a second end, wherein the first end is connected to the touch head; and
a signal cable having two ends on which a first signal connector head and a second signal connector head are respectively disposed, wherein the signal cable is combined with the pen body.

2. The touch pen according to claim 1, wherein the first signal connector head and the second signal connector head are disposed on the first end and the second end of the pen body, respectively.

3. The touch pen according to claim 2, wherein the pen body is formed with a strip-like slot having one end connected to the first end or the second end, and a width slightly smaller than or equal to a diameter of the signal cable.

4. The touch pen according to claim 3, wherein the pen body is made of a resilience material or a flexible material.

5. The touch pen according to claim 2, wherein the pen body comprises a first section and a second section, and a rotatable mechanism is disposed between and connected to the first section and the second section.

6. The touch pen according to claim 2, wherein the touch head comprises a connector head accommodating chamber, and the first signal connector head is disposed in the connector head accommodating chamber when the touch head is connected to the first end.

7. The touch pen according to claim 2, wherein the second end is further covered with a cover body.

8. The touch pen according to claim 1, wherein the pen body further has a clip.
